(19) United States
(12) Patent Application Publication
(10) Pub. No.: US 2004/0074138 A1
(43) Pub. Date: Apr. 22, 2004

(54) Insect control system

(76) Inventor: Eduardo Fleury Moreira, Palm City, FL (US)

Correspondence Address: SYNGENTA CROP PROTECTION , INC., PATENT AND TRADEMARK DEPARTMENT, 410 SWING ROAD, GREENSBORO, NC, 27409, US

(21) Appl. No.: 10/450,882

(22) PCT Filed: Dec. 20, 2001
(86) PCT No.: PCT/US01/50216

(51) Int. Cl. A01M 1/20

(52) U.S. Cl. 43/107

(57) ABSTRACT

The invention provides an insect control system for detecting, monitoring and/or controlling insects, such as termites. The insect control system comprises at least one control station for monitoring and/or baiting insects and at least one guide element which extends to areas surrounding the control stations and to areas that are conductive to insect activity. The guide element(s) facilitates an insect, such as termite, in locating a control station. The present system is more efficiency and advantageous over other bait or monitoring systems because of the facilitation of termites by the guide element(s) to the control stations(s).

### RELATED APPLICATIONS

This application claims priority to U.S. Provisional Application No. 60/256,742, filed Dec. 20, 2000.

### FIELD OF THE INVENTION

A device or system for detecting and controlling insect activity is described. The device comprises at least one insect control station for monitoring and/or baiting insects, and at least one guide element.

### BACKGROUND OF THE INVENTION

Standard methods of insect control include placing a pesticide material into the soil, under and around a structure creating a chemical barrier. The chemical barrier remains effective provided the insecticide is long lasting and there is no disruption of the chemical barrier.

Monitoring and bait stations for the detection and control of insects such as termites are also known. Typically, stations are positioned at locations closely surrounding the structure and at certain distances apart. Often monitoring stations having attractants, such as food, are set out and observed until termite activity is detected. Upon detection of insect activity in one or more stations, an insecticide is added to the station. Termite monitoring and control stations typically rely on random foraging behavior for food and water.

Studies of insect behavior reveal that insects such as termites may preferentially follow a physical reference if one is available. Termites may traverse areas such as tree roots, edges of driveways, cracks in concrete, pipes, garden edging and the like, in the search of food and water. There is a need in the art for new methods of controlling termites and other insects. The invention is directed to this as well as other important ends.

### SUMMARY OF THE INVENTION

The invention comprises a system for detecting, monitoring and/or controlling insects, such as termites. Control systems of the invention comprise at least one control station and at least one guide element extending from the control station. The guide element facilitates an insect, such as a termite, in locating a control station. The invention capitalizes upon the behavior of insects to preferentially traverse a physical reference, pathway or a conduit as described below. The control systems of the invention may be used alone, or in combination with other termite control procedures, such as chemical and/or physical barriers.

Where insect infestation is known to exist in a small or confined area, control systems may comprise a single control station having one or more guide elements. Alternately, control systems of the invention may comprise a network or matrix of monitoring or bait stations and a plurality of guide elements which extend to areas surrounding the control stations and to areas which are conducive to insect activity. Control stations useful in the practice of the invention include apparatuses such as those used in the field of termite detecting/monitoring or baiting. Guide elements may comprise, for example, tubes, pipes, twine or string-like material that extend from a control station to a surrounding area or structure, or that extend to an area of known infestation or an area which is conducive to insect activity.

### BRIEF DESCRIPTION OF THE DRAWING(S)

FIG. 1 is a sectional view showing an embodiment of an insect control system of the invention illustrating a control station, guide element and conducive area.

FIG. 2 is a top plan view of an embodiment of an insect control system of the invention illustrating a network of control stations and guide elements.

FIG. 3 is a side view of a bait monitoring station.

FIG. 4 is a side view of a completed test arena.

FIG. 5 is a top plan view of a completed test arena.

FIG. 6 is a top plan view of a test arena showing guides that do not connect to the termite introduction station.

### DETAILED DESCRIPTION OF THE INVENTION

The invention comprises an insect control system that includes at least one control station and at least one guide element. Control stations of the invention comprise monitoring or bait stations, or combinations thereof. The control stations may be an apparatus such as those used in the field of termite detecting/monitoring or baiting, and which contain toxic or non-toxic bait material that has been shown to be effective for the detection and removal of insects. Control systems of the invention may comprise one or more of in-ground, ground level and/or above-ground apparatuses. Examples of apparatuses that are suitable for use in the invention include those described in U.S. Pat. Nos. 6,065,241, 6,003,266, 5,901,496, 5,899,018, and 5,571,967, the disclosures of which are incorporated by reference herein in their entirety.

A guide element may comprise, for example, a guide, lead or traversing means that extends from a control station to a surrounding area or structure. The surrounding area or structure may include an area of known infestation or an area that is conducive to insect activity. Control systems of the invention may have one, but preferably two or more, insect control stations and one, but preferably two or more, guide elements.

The control systems of the invention comprise at least one guide element attached to or located proximate to at least one control station. Where at least one guide element is attached or affixed to at least one control station, guide elements may be attached to at least one bottom, top or side/lateral surface of the control station. The manner in which the components are attached may depend in part upon the selection of each component. For example, a guide element may be tied around, adhered to, projected from, or inserted into the control station. If the guide element is of a string-like or twine material, the guide element may be tied to or around the lateral surface of the station or through a hole in the station. If the control station has holes on the surface or protrusion from the surface, the guide element may be inserted through a hole or connected to the protrusion on a surface of the control station. In a preferred embodiment where the guide element is a tube, the guide element is inserted through a hole on the side surface of the control station. In a more preferred embodiment, two or more tubes are inserted through or attached to one or more side surfaces of the control station. In a most preferred embodiment, three or more tubes are attached to side portions of a control station.

In an alternative embodiment, the guide element is located proximate to the control station. By the term “proximate,” it is meant that at least one guide element is located close to, very near, or in immediate proximity to at least one control station. In one embodiment where at least one guide element is located proximate to the control station, the proximity of the guide element to the control station increases the likelihood or probability that an insect will locate a control station. In one embodiment, the guide element is located less than about 1 meter from the control station. In a preferred embodiment, the guide element is located less than about 60 centimeters from the control station. In an alternate embodiment, the guide element is located from about 1 millimeter to about 30 centimeters from the control station. In another preferred embodiment, the guide element is located from about 5 millimeters to about 20 centimeters from the control station.

In an alternate embodiment, a control system comprises a one-piece unit. In one embodiment comprising a one-piece control system, at least one guide element is an integral part of a control station where the guide element or elements extend from at least one portion of the control system including at least one of the top, bottom or lateral surfaces of the control station.

The guide elements of the invention extend from the control station to, for example, an area surrounding the control station including nearby structures, surfaces, and the like, or an insect conducive area In one embodiment, where at least one guide element extends from at least one control station to a surrounding area, insects that come in contact with the guide element traverse the element to enter the control station.

In an alternate embodiment, at least one guide element extends from at least one control station to an insect conducive area. For purposes of the invention, insect conducive areas include areas or structures around or in which insect activity is found or areas which may have a greater likelihood of insect infestation because they possess insect conducive conditions such as habitat, moisture and/or food source. Insect conducive areas, including termite conducive areas, may be above ground, underground or ground level and include but are not limited to, open areas and physical references such as edges, surfaces, conduits and the like, which insects inhabit or traverse or in which insects are otherwise present. Further conducive areas include, but are not limited to, cables such as electrical, telephone, and video cables, tubes and/or conduits, plumbing, gas, drain and sewage lines, edges or surfaces such as side walks and driveway edges, fence and wall edges, garden borders and edgings, and curbs. Other conducive areas include plants such as trees and shrubs, and roots thereof, as well as irrigation lines and sprinkler systems, garden electrical wires, dog/animal underground wiring or fencing systems, as well as swimming pool edges and plumbing, garden fabrics for ground cover, building slab or pillar, stucco, patios, external and/or internal heating and drain systems, wall forms (wood, stone, brick, concrete, polymeric, etc.), boxes including utilities, irrigation inspection, and metering boxes, in-wall pipes and conduits, structural frames and wall siding, heater and AC structures, bath traps, lighting and ground rods, and the like.

In one embodiment of the invention, control systems of the invention may be connected to or located in proximity to conducive areas or structures. At least one guide element may connect or attach directly to or be proximate to an insect conducive area By the term “proximate,” it is meant that at least one guide element is located close to, very near, or in immediate proximity to at least one conducive area. In one embodiment where at least one guide element is located proximate to the conducive area, the proximity of the guide element to the conducive area increases the likelihood or probability that an insect will locate a guide element. In one embodiment, the guide element is located less than about 1 meter from the conducive area. In a preferred embodiment, the guide element is located less than about 60 centimeters from the conducive area. In an alternate embodiment, the guide element is located from about 1 millimeter to about 30 centimeters from the conducive area. In another preferred embodiment, the guide element is located from about 5 millimeters to about 20 centimeters from the conducive area.

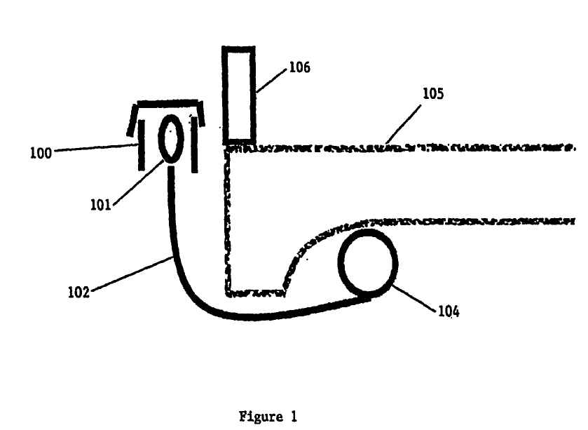

For example, a guide element may extend from a control station to a termite conducive area such as a pipe. FIG. 1 depicts a control station 100 with bait or monitoring material 101 from which a guide element 102 is connected to or is proximate to a plumbing line 104 located under a concrete slab 105 of a housing structure 106. In a preferred embodiment, two or more than two guide elements extend from a control station to one insect conducive area In a further preferred embodiment, two or more than two, guide elements extend from a control station to two or more than two, insect conducive areas. The guide means may be attached to or located proximate to both the control stations and the insect conducive areas.

In a further embodiment of the present invention more than one, more than two or a plurality of guide elements extend from at least one station to the surrounding area. The guide elements may be arranged to form a control system as a matrix, network or grid. At least one guide element may extend to an area without further attachment or connection, and alternately, at least one guide element may attach or connect to other guide elements. In a further embodiment, at least some of the guide elements of the network, matrix or grid control system may connect or attach directly to one or more insect conducive area or structure, such as pipes and walls. Alternately, the guide elements may be located in proximity to a conducive area without directly contacting the areas.

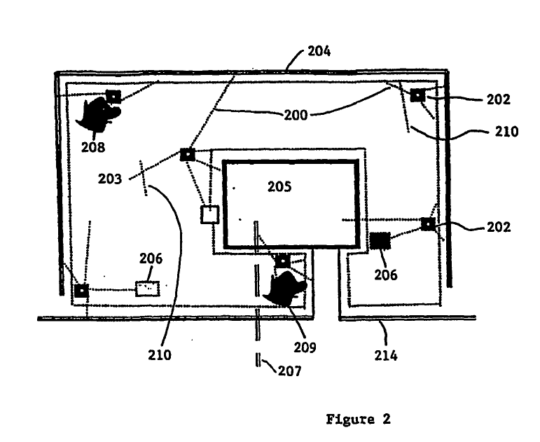

FIG. 2 depicts a control system comprising a plurality or multiplicity of control stations and a plurality or multiplicity of guide elements extending therefrom. Control stations are located around a structure and insect conducive areas, and the guide elements that are attached or proximate to the control stations extend either proximate to or attached to the surrounding area and insect conducive areas. Guide elements 200 are attached to or located proximate to control stations 202, and extend to surrounding areas 203, fencing 204, curb 214, housing structure 205, utilities 206, plumbing and sewer 207, trees 208 and shrubs 209, and other guide elements 210. FIG. 2 further depicts a control system in which the control stations and guide elements are arranged to form a network around the area to be monitored or controlled. The guide elements may be present as both horizontal and/or vertical grids, networks or matrices. The guide elements may extend under, in and/or around a surrounding area or insect conducive area such as structures and plants, linking the conducive areas to the monitoring/bait station.

In one embodiment, an insect control system of the invention may be used above ground. For example, a termite control system having at least one control station and at least one guide element may be located on the roof of a structure. Where the control system is used above ground, it may be preferable to use dark tubing as a guide element.

Guide elements may be formed so the insect can traverse along, through or across the inner or outer surface of the element. Guide elements of the invention include shapes, forms or structures such as tubes, wires, tapes, twine or string-like materials. Guide elements may be hollow or solid, with or without holes, rigid or flexible and may be comprised of various material compositions including but not limited to polymers, such as high and low density organic polymers, rubber, metal, ceramic, wood, fibers, plastic, cellulose, bioplastic, biodegradable material or combinations of materials. Where the guide element comprises a string-like or twine materials the material may for example be selected from natural or man-made materials such as cotton, nylon, sisal, jute, metal, fibers or a combination of materials. The selection of the guide element composition may depend upon the environmental conditions in which it is located.

In one embodiment where the control system comprises at least one guide element which comprises a hollow tube, at least a portion of the guide element may comprise holes extending through the lateral surface of the tube wall through which an insect can enter and exit the tube. This is particularly advantageous, for example, where at least a portion of a guide element is located underground and the movement of the insect is facilitated by traversing the inner surface of a guide element.

Combination of materials and shapes or forms may also be used for guide elements. For example a hollow or solid guide element may comprise branched or unbranched shapes such as I-, U-, L-, or V-, or Y- shaped, or a grooved, corrugated, spiral, chain, flat, or twisted shape or form. Guide elements may further comprise lateral hair, fiber, barbs or spines to create additional lateral guide surface along the surface of the guide elements. A preferred insect control system of the invention comprises a termite control station having at least one guide element with at least one branch wherein the guide element can extend to more than one surrounding area or conducive area.

In one embodiment at least a portion of a guide element is used in combination with an attractant, bait or food, or insect harborage. An attractant may be natural or man made attractants, such as pheromones, microbial organisms (fungus, bacteria, etc), their byproducts, or combinations thereof. Alternately, the where the guide element is used with a bait or food, such as a termite control system, material such as cellulose or other conducive material is used, or a termite harborage material such as styrofoam, soil or fibers may be used. The attractants, bait or food materials may be located in or around the guide element or may be incorporated into the guide element during the formation of the element, such as a string or twine comprising a cellulose material Alternatively, a guide element comprising a tube shape may be filled with a conducive or bait material. Further, a guide element comprising an extrudable material, such as a polymer, may be blended with an attractant or food material prior to the extrusion process.

The control stations of the invention can be installed both pre- and post construction, or for example, during the installation of fences, patios, pipes or irrigation systems. Where the control stations are installed pre-construction the guide elements may extend under the foundation of a structure and directly attach to a conducive area such as a pipe or utility line. Where the control systems are installed post construction, it may be less feasible to attach the guide elements directly to a conducive area such as one under a foundation, and the guide elements may be placed proximate to the conducive area depending on the location of the conducive area. Further, guide elements may be installed by injection from above ground by machines or dug in place.

### EXAMPLE

The following example is for purposes of illustration only, and is not intended to limit the scope of the appended claims.

As shown in the example below, the presence of guides greatly reduces the time required for termites to find a monitoring bait.

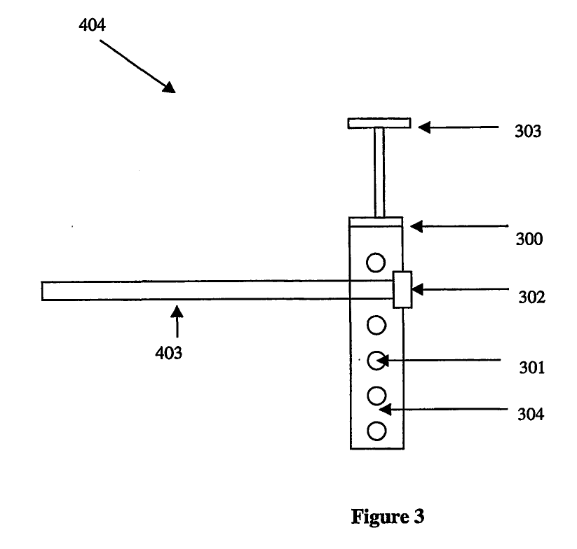

In FIG. 3, bait monitoring stations 404 were constructed from 12.5 ml plastic syringes 300 (Gilson DistriTip) with the tip cut off. Each station had 4 rows of 5, 5 mm holes 301 melted into them with a soldering iron. Stations to be used with guides had a 5 mm width plastic cable tie 302 secured around them 3 cm below the top. Each station had a 5 cm filter paper (Whatmans number 1) rolled and pushed into the barrel 304. The syringe plunger 303 was used to seal the open top of the syringe. The bait monitoring stations 404 may have other dimensions and/or shapes.

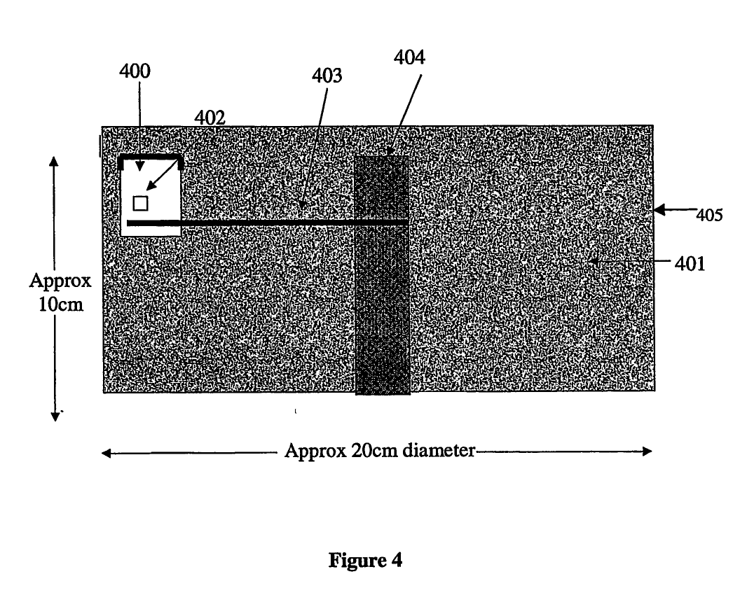

In FIGS. 4-6, termite introduction stations 400 were constructed from a 4 cm diameter, 3 cm depth plastic pot (Mono plastics), with a 5 mm diameter hole melted into the side of the pot, just above the base. As shown in FIG. 4, a small amount of paper 402 is placed into the termite introduction station 400 and acts as an attractant and an incentive for the termites to remain in the termite introduction station 400.

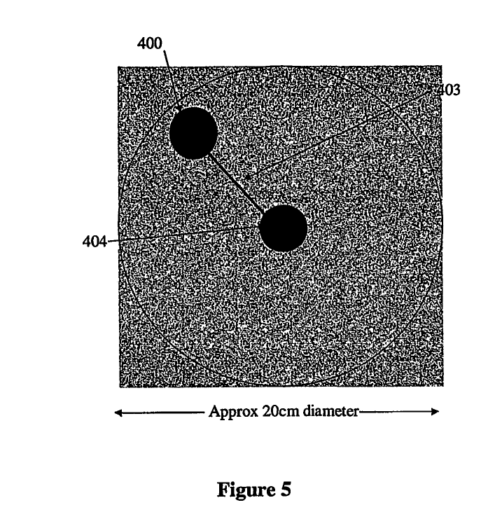

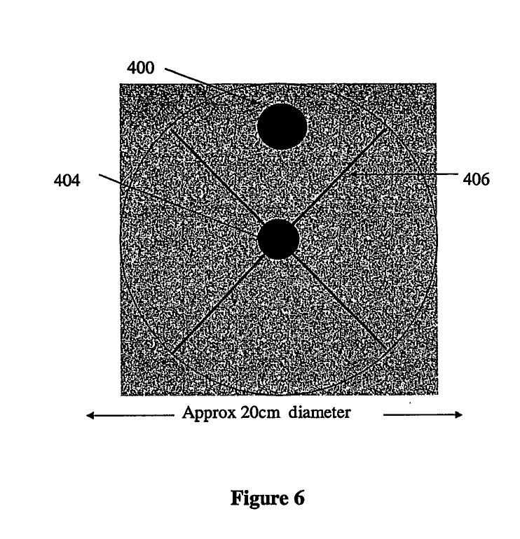

The test arena were constructed from 20 cm diameter, 10 cm depth, glass crystallizing dishes 405. Sandy loam soil 401 was sieved through a 2 mm sieve, and de-ionized water added to give a moisture content of 10% w/w. Approximately lcm of the prepared soil was added to the bottom of the crystallizing dish 405. The bait monitoring stations 404 were placed onto the soil in the center of the dish, and held in place while a further 4 cm of soil were added, half burying them. The termite introduction station 400 was then placed on the soil at the edge of the arena As shown in FIG. 5, if a connecting guide 403 was being used, it was placed through the hole in the termite introduction station 400. If a non-connecting guide 406 was being used, the termite introduction station 400 was placed between the guides 406, as shown in FIG. 6. Further soil was then added until it was flush with the top of the two stations. The arenas were gentle tapped and shaken to settle the soil, adding more soil if the level fell.

b 100 mixed age Reticulitermes flavipes ex Florida, with at least one and no more than two soldiers, were added to the termite introduction station 400 and sealed in place with an air tight lid. The arenas were stored at 28° C. and 85% relative humidity in the dark.

Assessments were made by removing the plunger 303 from the bait monitoring station 404 and looking for the presence of termites. The plunger 303 was carefully removed and replaced to minimize any movement of the monitoring station 404 or bait guides 403.

Three treatments were tested. In each instance, the time it took for the termites to find the bait was measured. In the first trial, no guides were used. In the second trial, guides 406 not connected to the termite introduction station 400 were used (e.g., FIG. 6). In the third trial, guides 403 connected to the termite introduction 400 and bait monitoring stations 404 were used (e.g., FIG. 5). The results show three replicates for each treatment.

### Results

Time taken to find bait:

| Replicate: | Without guide | Non-connecting guides | Connecting guides |
|---|---|---|---|
| 1 | 7 days | 5 days | 10 minutes |
| 2 | 7 days | 8 days | 45 minutes |
| 3 | 13 days | — | 2 hours |

The addition of connecting bait guides greatly reduced the time required by the termites to find the monitoring bait. The treatments with non-connecting guides took a similar time to find the monitoring stations than those with no guides. The ends of the guides were in contact with the sides of the glass arena. It is unlikely that the termites will find a guide in a three dimensional environment, however, once found they rapidly follow it to the monitoring bait station. It is unlikely that the guides will be placed in direct contact with termites in the field. Placement of baits next to pre-existing guides may be an alternative method. Such pre-existing guides include pipes and cables. Permanent bait stations could be fitted to the cables or pipes when they are being laid. These stations could be baited at a later date. This would have the advantage of avoiding post construction bait placement next to utility pipes or cables, with the intrinsic risk this entails.

The control stations of the invention are advantageous over other bait or monitoring systems among other reasons, because of the facilitation of termites in locating the control stations. Where guide elements facilitate the movement of termites to the stations, the system is more efficient. Termites may locate stations faster than isolated bait stations resulting in faster control if infestation already exists. Further, guide elements may enable the insect control stations to be located-further from a home or other structure, and where matrices of guide elements attract insects from over a larger areas fewer stations may be required to be installed, therefore increasing the efficiency of inspection, yielding faster and more accurate service.

Although the invention has been set forth in detail, one skilled in the art will appreciate that numerous changes and modifications can be made to the invention without departing from the spirit or scope thereof.

What is claimed is:

1. An insect control system comprising at least one control station and at least one guide element extending from the at least one control station.

2. The insect control system of claim 1 having more than two guide elements.

3. The insect control system of claim 1 where at least one guide element is located proximate to at least one control station.

4. The insect control system of claim 1 where at least one guide element is attached to at least one control station.

5. The insect control system of claim 1 where at least one guide element is attached to a top or bottom surface of a control station,

6. The insect control system of claim 1 where at least one guide element is attached to at least one other guide element.

7. The insect control system of claim 1 wherein at least one guide element is branched.

8. An insect control system comprising at least one control station and at least one guide element extending to an insect conducive area.

9. The insect control system of claim 8 wherein at least one guide element is attached to or proximate to an insect conducive area.

10. An insect control system comprising at least one guide element forming a network.

11. A method of controlling insect infestation comprising placing at least one control station and at least one guide element near a site of insect infestation and extending at least one guide element to the site of infestation.

12. The insect control system of claim 1, wherein the at least one guide element extends from a lateral side surface of the at least one control station.
